(19) United States
(12) Patent Application Publication
(10) Pub. No.: US 2017/0327180 A1
(43) Pub. Date: Nov. 16, 2017

(54) APPARATUS, SYSTEM, AND METHOD TO ADJUST A HEIGHT OF A HANDLEBAR

(71) Applicant: Matthew Hasenyager, North Ogden, UT (US)

(72) Inventor: Matthew Hasenyager, North Ogden, UT (US)

(21) Appl. No.: 15/595,846

(22) Filed: May 15, 2017

Related U.S. Application Data
(60) Provisional application No. 62/336,337, filed on May 13, 2016.

(51) Int. Cl. B62K 21/16; B62K 21/22; B62K 19/32

(52) U.S. Cl. CPC B62K 21/16; B62K 19/32; B62K 21/22

(57) ABSTRACT

An apparatus, system, and method are disclosed for adjusting a height of a handlebar. The apparatus includes a steering tube coupling member, a handlebar coupling member, at least one connector and a height adjusting member. The at least one connector adjustably couples the steering tube coupling member to the handlebar coupling member. The height adjusting member is coupled to at least one of the steering tube coupling member, the handle bar coupling member, and the at least one connector. Actuation of the height adjusting member selectively adjusts a height of the handlebar coupling member relative to a height of the steering tube coupling member to selectively adjust a height of the handlebars.

### CROSS-REFERENCES TO RELATED APPLICATIONS

This application claims the benefit of U.S. Provisional Patent Application No. 62/336,337 entitled “APPARATUS, SYSTEM, AND METHOD TO ADJUST A HEIGHT OF A HANDLEBAR” and filed on May 13, 2016 for Matthew Hasenyager, which is incorporated herein by reference.

### FIELD OF THE INVENTION

This invention relates to bicycle geometry and more particularly relates to an adjustable bicycle stem.

### BACKGROUND

A bicycle frame is the main component of a bicycle, onto which wheels and other components are fitted. The most common frame design for an upright bicycle consists of two triangles: a main triangle and a paired rear triangle. Bicyclists take great care in selecting a proper sized frame. A properly sized bicycle frame will lead to more efficient riding and may help reduce injuries due to the repetitive motions associated with pedaling a bicycle. However, a properly sized frame is only the beginning step in sizing a frame for a particular individual. Once the proper sized bicycle frame is purchased or otherwise obtained, the bicyclist should adjust the bicycle components to properly fit the bicycle to the rider.

The first step in fitting a bicycle to a user is adjusting a height of the bicycle's seat or saddle to fit the user. The height of the bicycle's seat or saddle is typically adjusted such that the user's knee is slightly bent when the user's foot is at the bottom of the pedal stroke. Adjusting the height of the bicycle seat is typically a straightforward and easy process. A bicycle seatpost extends upwards from the bicycle frame to the saddle. The amount that the bicycle seatpost extends out of the frame can be adjusted to raise or lower the height of the bicycle seat. The seatpost is inserted into the seat tube, which is of a very slightly larger diameter (or a cylindrical shim can be used). The seatpost is held in place by squeezing the top of the seat tube with a tightening ring (temporarily reducing its diameter; a vertical slit cut into the tube allows this to happen without crumpling) until the tube firmly hugs the post where it leaves the frame. Typically, a quick-release mechanism allows easy height adjustment of the seat without the necessity of any tools. Thus, the bicyclist can make micro adjustments to the height of the seat even when the bicyclist is on the road or trail.

The height of the handlebars should also be adjusted to position the bicyclist in a comfortable position. Handlebar height, also known as saddle-drop, is the measurement of how far the top of the bicycle seat sits above or below the handlebars. A beginner will typically want the handlebars positioned even with the bicycle seat while experienced riders may wish to drop the position of the handlebars. Lowering the height of the handlebars reduces a bicyclist's center of gravity and increases traction to the front wheel of the bicycle by placing more of the bicyclist's weight over the front wheel. However, lowering the handlebars too much can make the bicycle difficult to control.

Adjusting the height of the bicycle's handlebars is a difficult process when compared to adjusting the height of the bicycle's seat. To adjust the height of the bicycle's handlebars, the bicyclist must remove the bicycle stem from the steering tube by loosening the stems clamping bolts using a hex key or another appropriate tool. Once the bicycle stem has been removed, the user can remove one or more metal spacers from the steering tube to allow the bicycle stem to be positioned at a lower position on the steering tube. The spacers that have been removed are then placed on the steering tube above the bicycle stem to avoid losing the spacers.

Obviously, the process of adjusting the height of the bicycle's handlebars is much more difficult than raising or lowering the height of the bicycle seat. For example, adjusting the height of the bicycle's handlebars may be difficult or impossible to accomplish when the bicyclist is on the road or trail given the tools required to adjust the height of the bicycle's handlebars.

Furthermore, the current process for adjusting the height of a bicycle's handlebars does not allow a bicyclist to adjust the height of the bicycle's handlebars on the fly as the bicyclist is pedaling the bicycle. For example, in certain circumstances a rider may wish to position the bicycles handlebars at one position for ascending a hill and another position when descending a hill. With the current process for adjusting the height of a bicycle's handlebars, the bicyclist would need to dismount the bicycle and proceed through the process outlined above for each hill they encounter.

Another drawback to the current process for adjusting the height of a bicycle's handlebars is that the adjustment of the bicycle's handlebars is limited by the length of the bicycle's steering tube. A bicyclist who wants to position the handlebars at a higher or lower position than can be accommodated by the steering tube will need to replace the bicycle stem with a bicycle stem with a higher or lower geometry.

### SUMMARY

From the foregoing discussion, it should be apparent that a need exists for an apparatus, system, and method to adjust a height of a handlebar that requires little or no tools. Beneficially, such an apparatus, system, and method would be adjustable on the fly and provide a greater range of height adjustments than any currently available bicycle stems.

The present invention has been developed in response to the present state of the art, and in response to the problems and needs in the art that have not yet been fully solved by currently available bicycle stems. Accordingly, the present invention has been developed to provide an apparatus, system, and method for a bicycle stem that overcome many or all of the above-discussed shortcomings in the art.

The apparatus to adjust a height of a handlebar, in one embodiment, includes a steering tube coupling member, a handlebar coupling member, at least one connector and a height adjusting member. The at least one connector adjustably couples the steering tube coupling member to the handlebar coupling member. The height adjusting member is coupled to at least one of the steering tube coupling member, the handle bar coupling member and the at least one connector. Actuation of the height adjusting member selectively adjusts a height of the handlebar coupling member relative to a height of the steering tube coupling member to selectively adjust a height of the handlebars.

In one embodiment, the height adjusting member is a linear actuator that is configured to extend and retract linearly along a longitudinal axis. Examples of suitable linear actuators include a hydraulic actuator, a pneumatic actuator, a piezoelectric actuator, a mechanical actuator, a mechanical lever, an electro mechanical actuator and the like.

In certain embodiments, the apparatus also includes a controller coupled to the height adjusting member. In such an embodiment, the controller is configured to selectively deliver a control signal to the height adjusting member. For example, in one embodiment, the height adjusting member is a hydraulic piston and the control signal is delivery of a hydraulic fluid to the hydraulic piston. Delivery of hydraulic fluid to the height adjusting member extends a length of the height adjusting member to position the handlebar coupling member in a raised position relative to a position of the steering tube coupling member.

In another embodiment, the control signal includes removal of at least a portion of a hydraulic fluid from the hydraulic piston. In such an embodiment, the removal of all or a portion of the hydraulic fluid from the hydraulic piston reduces a length of the hydraulic piston to position the handlebar coupling member in a lowered position relative to a position of the steering tube coupling member. In either embodiment, extending the length of the height adjusting member positions the handlebar coupling member in a raised position relative to the steering tube coupling member and reducing the length of the height adjusting member positions the handlebar coupling member in a lowered position. In the lowered position, the handlebar coupling member is positioned at a lower position relative to the steering tube coupling member than in the raised position.

Of course, one of skill in the art will recognize that in embodiments wherein the height adjusting member is a hydraulic actuator, a pneumatic actuator, a piezoelectric actuator, a mechanical actuator, a mechanical lever, or an electro mechanical actuator, the controller is configured to deliver the appropriate control signal (i.e., electric voltage or current, pneumatic or hydraulic pressure, or even human power).

In one embodiment, the apparatus also includes a first connector and a second connector. The first connector is pivotably coupled to a top end of the steering tube coupling member at a first end on the first connector. The first connector is also pivotably coupled to a top end of the handlebar coupling member at a second end of the first connector. The second connector is pivotably coupled to a bottom end of the steering tube coupling member at a first end on the second connector. The second connector is also pivotably coupled to a bottom end of the handlebar coupling member at a second end of the second connector. In an exemplary embodiment, the first connector remains substantially parallel to the second connector when the height of the handle bar coupling member is adjusted relative to the height of the steering tube coupling member.

In another embodiment, the height adjusting member is pivotably coupled to the bottom end of the steering tube coupling member at the first end of the height adjusting member. In such an embodiment, the height adjusting member is pivotably coupled to the top end of the handle bar coupling member at the second end of the height adjusting member. Delivery of hydraulic fluid to the height adjusting member extends a length of the height adjusting member to position the handlebar coupling member in a raised position relative to the steering tube coupling member. Alternatively, removal of hydraulic fluid from the height adjusting member reduces a length of the height adjusting member to position the handlebar coupling member in a lowered position. In the lowered position, the handlebar coupling member is positioned at a lower position relative to the steering tube coupling member than in the raised position.

Reference throughout this specification to features, advantages, or similar language does not imply that all the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail using the accompanying drawings, in which:

FIG. 1A is a side view illustrating one embodiment of a prior art bicycle;

FIG. 1B is a perspective view illustrating the bicycle fork of FIG. 1A with the bicycle fork removed from within the head tube of the bicycle frame;

FIG. 2 is a perspective view illustrating one embodiment of an apparatus to adjust a height of a handlebar in accordance with the present invention;

FIG. 3A is a side view illustrating an apparatus to adjust a height of a handlebar with the handlebar coupling member positioned in a raised position in accordance with one embodiment of the present invention;

FIG. 3B is a side view further illustrating the apparatus to adjust a height of a handlebar of FIG. 3A with the handlebar coupling member positioned in a lowered position in accordance with one embodiment of the present invention; and

FIG. 4 is a side view illustrating an apparatus to adjust a height of a handlebar with the handlebar coupling member positioned in a raised position in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

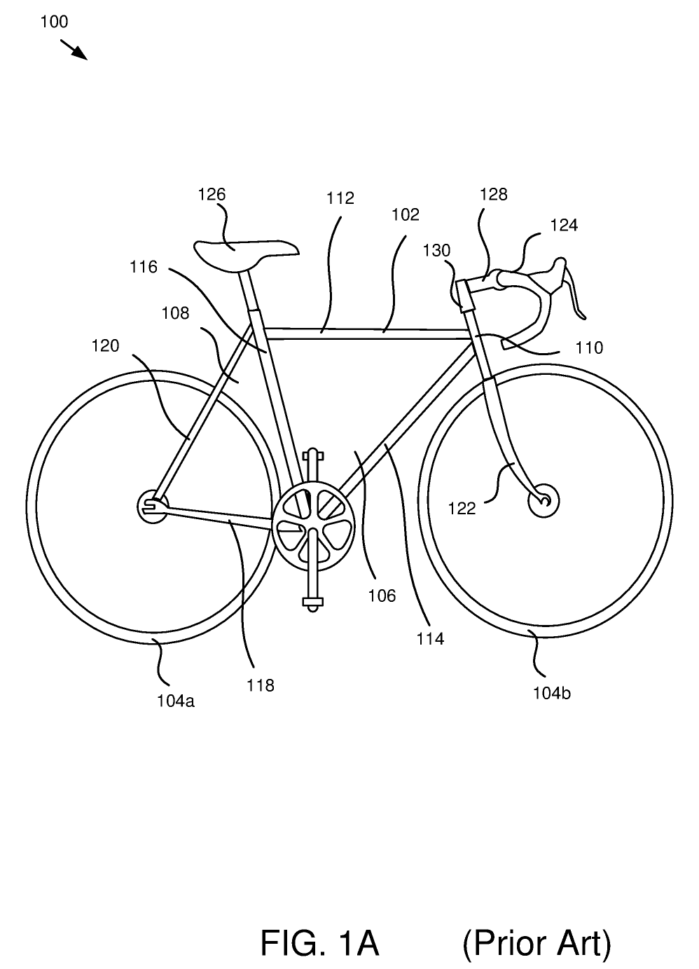

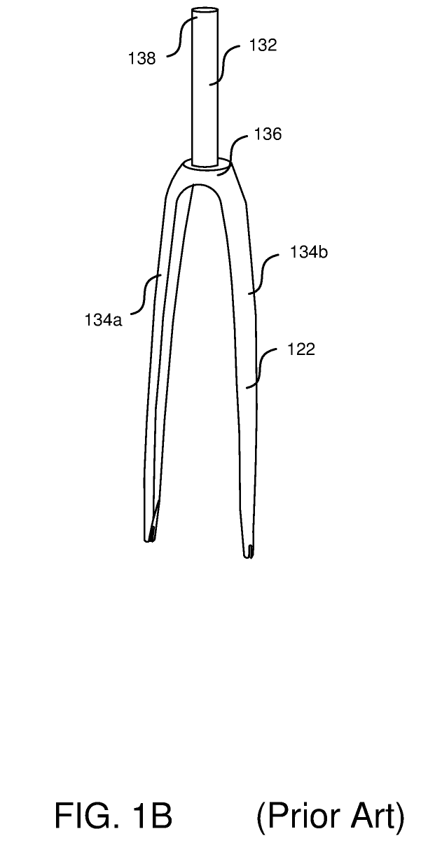

FIG. 1A is a side view illustrating one embodiment of a prior art bicycle 100. A bicycle frame 102 is the main component of a bicycle 100, onto which wheels 104a and 104b and other components are fitted. The modern and most common frame design for an upright bicycle 100 and consists of two triangles, a main triangle 106 and a paired rear triangle 108. Frames 102 are required to be strong, stiff and light, which they do by combining different materials and shapes.

The main triangle 106 consists of the head tube 110, top tube 112, down tube 114 and seat tube 116. The rear triangle 108 consists of the seat tube 116, and paired chain stays 118 and seat stays 120. The head tube 110 contains a headset, the bearings for the fork 122 via its steering tube 132 (See, FIG. 1B). In an integrated headset, cartridge bearings interface directly with the surface on the inside of the head tube 110, on non-integrated headsets the bearings (in a cartridge or not) interface with “cups” pressed into the head tube 110.

The length of the tubes, and the angles at which they are attached define a frame geometry. In comparing different frame geometries, designers often compare the seat tube 116 angle, head tube 110 angle, top tube 112 length, and seat tube 116 length. The geometry of the frame 102 depends on the intended use. For instance, a road bicycle will place the handlebars 124 in a lower and further position relative to the saddle 126 giving a more crouched riding position; whereas a utility bicycle emphasizes comfort and has higher handlebars 124 resulting in a more upright riding position. While the embodiment illustrated in FIG. 1A depicts a road bicycle 100, one of skill in the art will recognize that frame geometry is equally important in mountain biking as well as bicycle motocross (BMX).

The stem 128 is the component on a bicycle 100 that connects the handlebars 124 to the steering tube 132 of the bicycle fork 122. Heretofore, handlebar 124 height depended on a length of the downtube portion 130 of the stem 128 or on the length of the steering tube 132 of the bicycle fork 122. The handlebar 124 height could not be adjusted on the fly to accommodate different riding conditions.

FIG. 1B is a perspective view illustrating the bicycle fork 122 of FIG. 1A with the bicycle fork 122 removed from within the head tube 110 of the bicycle frame 102. The bicycle fork 122 is the part of a bicycle that holds the front wheel 104b. A fork 122 typically consists of two blades 134a and 134b which are joined at the top by a fork crown 136. Above the crown 136, the steering tube 132 attaches the fork to the bicycle by being inserted into and through the head tube 110 of the bicycle frame 102.

The fork crown 136 abuts the head tube 110 to keep the steering tube 132 from extending all the way through head tube 110. The top end 138 of the steering tube 132 extends above the head tube 110 and provides an attachment point to couple the stem 128 to the fork 122. To raise the handlebars 124, spacers are positioned on the steering tube 132 between the top of the head tube 110 or a headset (bearings at the top of the head tube 110) and the stem 128. To lower the handlebars 124, the spacers are removed allowing the stem 128 to rest at a lower position on the steering tube 132. Of course, one of skill in the art will recognize that the maximum height of the handlebars 124 is dependent on the length of the steering tube 132. If a user desires a greater height for the handlebars 124 than can be accommodated by the steering tube 132, the user must purchase a fork 122 with a longer steering tube 132. Alternatively, the user may replace the stem 128 with a stem 128 having a higher geometry. Neither of these alternatives provides a system for quickly and easily adjusting the height of the handlebars 124.

As discussed above, the process of raising or lowering the height of the handlebars 124 per conventional methods is rather involved, requires the use of tools to remove the stem 128, and cannot be done on the fly while the bicyclist remains on the bicycle. The present subject matter is directed to an apparatus, system, and method for adjusting a height of the handlebars 124. Beneficially, the adjustment of the height of the handlebars 124 can be done on the fly, while the user is riding the bicycle 100.

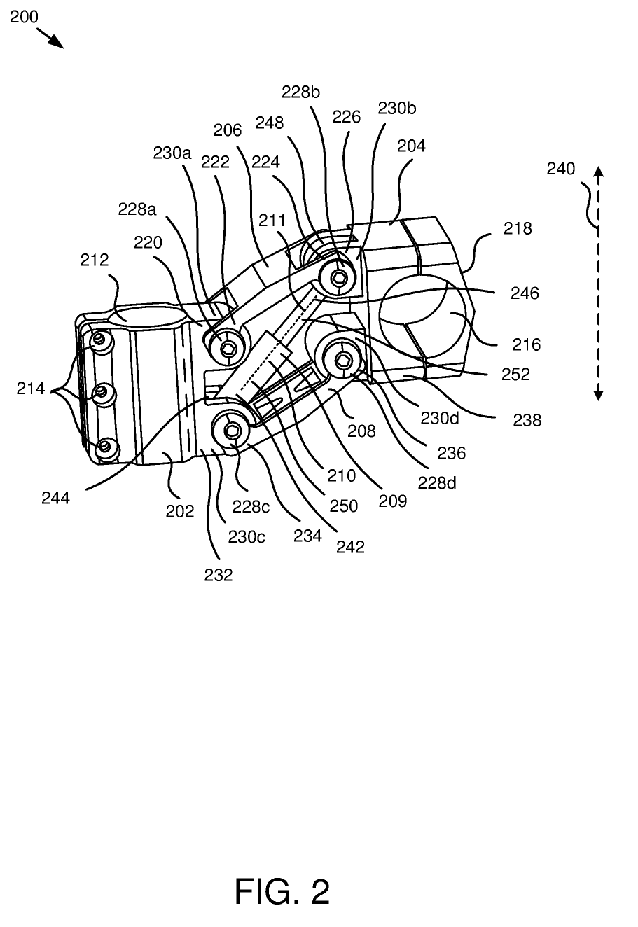

FIG. 2 is a perspective view illustrating one embodiment of an apparatus 200 to adjust a height of a handlebar 124 in accordance with the present invention. The apparatus 200, in certain embodiments, includes a steering tube coupling member 202, a handlebar coupling member 204, a first connector 206, a second connector 208, and a height adjusting member 209.

The steering tube coupling member 202, in one embodiment, comprises a clamp 212 for attaching to the steering tube 132 of the fork 122 of a bicycle 100. To couple the steering tube coupling member 202 to the steering tube 132 of the fork 122, the steering tube 132 of the fork 122 is positioned within the clamp 212 and a series of fastening elements (not shown) such as screws or bolts are positioned through bolt holes 214. The fastening elements are tightened to prevent rotation of the steering tube 132 of the fork 122 with respect to the clamp 212. Accordingly, when the steering tube coupling member 202 is coupled to the steering tube 132 of the fork 122, rotation of the steering tube coupling member 202 operates to rotate the fork 122 and thus steer the bicycle 100.

The handlebar coupling member 204, in certain embodiments, also includes a clamp 216 for coupling the handlebar coupling member 204 to handlebars 124. To couple the handlebars 124 to the handlebar coupling member 204, the handlebars 124 are positioned within the clamp 216 and one or more fastening elements (not shown) such as screws or bolts are inserted into bolt holes (not shown) in the front end 218 of the handlebar coupling member 204. The fastening elements are tightened to prevent rotation of the handlebars 124 with respect to the clamp 216 of the handlebar coupling member 204.

The first connector 206 is pivotably coupled to a top end 220 of the steering tube coupling member 202 at a first end 222 of the first connector 206. A second end 224 of the first connector 206 is pivotably coupled to a top end 226 of the handlebar coupling member 204. To pivotably couple the first connector 206 to the steering tube coupling member 202 and to the handlebar coupling member 204, fastening elements 228a and 228b are positioned through the first end 222 of the first connector 206 and through the second end 224 of the first connector 206 respectively. Fastening element 228a extends through flange 230a to couple the first end 222 of the first connector 206 to the steering tube coupling member 202. Fastening element 228b extends through flange 230b to couple the second end 224 of the first connector 206 to the handlebar coupling member 204. The first connector 206 is pivotable about fastening elements 228a and 228b to adjust a height of the handlebar coupling member 204 with respect to the steering tube coupling member 202.

The second connector 208 is pivotably coupled to a bottom end 232 of the steering tube coupling member 202 at a first end 234 of the second connector 208. A second end 236 of the second connector 208 is pivotably coupled to a bottom end 238 of the handlebar coupling member 204. To pivotably couple the second connector 208 to the steering tube coupling member 202 and to the handlebar coupling member 204, fastening elements 228c and 228d are positioned through the first end 234 of the second connector 208 and through the second end 236 of the second connector 208 respectively. Fastening element 228c extends through flange 230c to couple the first end 234 of the second connector 208 to the steering tube coupling member 202. Fastening element 228d extends through flange 230d to couple the second end 236 of the second connector 208 to the handlebar coupling member 204. The second connector 206 is pivotable about fastening elements 228c and 228d to adjust a height of the handlebar coupling member 204 with respect to the steering tube coupling member 202.

In certain embodiments, the first connector 206 remains substantially parallel to the second connector 208 when the height of the handlebar coupling member 204 is adjusted relative to the height of the steering tube coupling member 202. That is, in one embodiment, as the height of the handlebar coupling member 204 is adjusted in the directions indicated by arrow 240, the first connector 206 remains substantially parallel to the second connector 208. Because the handlebars 124 are received within clamp 216 of the handlebar coupling member 204, adjustment of the height of the handlebar coupling member 204 operates to adjust the height of the handlebars 124.

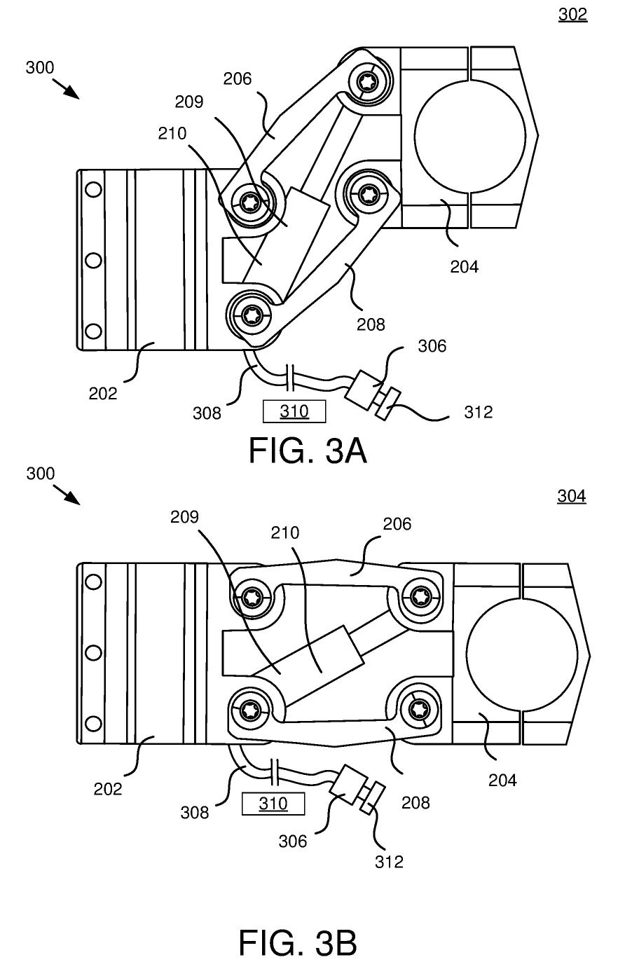

In certain embodiments, the height adjusting member 209 comprises a linear height adjusting member configured to give a unidirectional force through a unidirectional stroke. That is, the height adjusting member 209 creates motion in a straight line along a longitudinal axis 211 of the height adjusting member 209 to either force the height adjusting member to extend or retract linearly in response to a control signal 310 (See, FIGS. 3A and 3B) received from a controller 306 (See, FIGS. 3A and 3B). In the embodiments illustrated in FIGS. 2, 3A and 3B, the height adjusting member 209 is a hydraulic piston 210. However, one of skill in the art will recognize that in other embodiments, the height adjusting member 209 may be any other type of height adjusting member configured to raise or lower the height of the handlebar coupling member 204 with respect to the height of the steering tube coupling member 202. Examples of a suitable linear height adjusting member 209 include a hydraulic actuator, a pneumatic actuator, a piezoelectric actuator, a mechanical actuator, an electro mechanical actuator etc.

As discussed above, in the embodiments illustrated in FIGS. 2, 3A and 3B, the height adjusting member 209 is a hydraulic piston 210. The height adjusting member 209 is pivotably coupled to the bottom end 232 of the steering tube coupling member 202 at a first end 242 of the height adjusting member 209. To couple the first end 242 of the height adjusting member 209 to the bottom end 232 of the steering tube coupling member 202, the first end 242 of the height adjusting member 209 is positioned within a gap 244 in the flange 230c on the bottom end 232 of the steering tube coupling member 202. The first end 242 of the height adjusting member 209 includes an orifice (not shown) through which fastening element 228c extends to pivotably couple the first end 242 of the height adjusting member 209 to the bottom end 232 of the steering tube coupling member 202.

A second end 246 of the height adjusting member 209 is positioned within a gap 248 in the flange 230b on the top end 226 of the handlebar coupling member 204. The second end 246 of the height adjusting member 209, like the first end 242 of the height adjusting member 209, also includes an orifice (not shown). Fastening element 228b extends through the flange 230b on the top end 226 of the handlebar coupling member 204 and through the orifice in the second end 246 of the height adjusting member 209 to pivotably couple the second end 246 of the height adjusting member 209 to the top end 226 of the handlebar coupling member 204.

While the embodiment illustrated in FIG. 2 depicts the first end 242 of the height adjusting member 209 as being pivotably coupled to the bottom end 232 of the steering tube coupling member 202 and the second end 246 of the height adjusting member 209 as being pivotably coupled to the top end 226 of the handlebar coupling member 204, one of skill in the art will recognize that in other embodiments the couplings may be reversed. That is, in certain embodiments, the first end 242 of the height adjusting member 209 may be pivotably coupled to the flange 230a on the top end 220 of the steering tube coupling member 202 and the second end 246 of the height adjusting member 209 may be pivotably coupled to the flange 230d on the bottom end 238 of the handlebar coupling member 204. Further, one of skill in the art will recognize that the arrangement of the height adjusting member 209 may be reversed with the hydraulic piston reservoir 250 coupled to the top end 226 of the handlebar coupling member 204 and the hydraulic piston shaft 250 coupled to the top end 226 of the handlebar coupling member 204. Of course, the same is true of embodiments wherein the height adjusting member 209 is pivotably coupled to the flange 230a on the top end 220 of the steering tube coupling member 202 and to the flange 230d on the bottom end 238 of the handlebar coupling member 204.

Again, it should be evident that while the embodiments illustrated in FIGS. 2, 3A and 3B, depict the height adjusting member 209 as a hydraulic piston 210, in other embodiments, the height adjusting member 209 may be any other suitable height adjusting member 209 including a pneumatic actuator, a piezoelectric actuator, a mechanical actuator, an electro mechanical actuator etc. In such embodiments, opposing ends of such height adjusting members are pivotably coupleable to the steering tube coupling member 202 and the handlebar coupling member 204 at opposing ends of the height adjusting member 209 in a manner substantially similar to the manner in which the hydraulic piston 210 is pivotably coupled to the steering tube coupling member 202 and the handlebar coupling member 204 at opposing ends (i.e., the first end 242 and the second end 246).

FIG. 3A is a side view illustrating an apparatus 300 to adjust a height of a handlebar 124 with the handlebar coupling member 204 positioned in a raised position 302 in accordance with one embodiment of the present invention. FIG. 3B is a side view further illustrating the apparatus 300 to adjust a height of a handlebar 124 of FIG. 3A with the handlebar coupling member 204 positioned in a lowered position 304 in accordance with another embodiment of the present invention.

The apparatus 300 of FIGS. 3A and 3B is substantially similar to the apparatus 200 of FIG. 2. Accordingly, in certain embodiments, the apparatus 300 includes a steering tube coupling member 202, a handlebar coupling member 204, a first connector 206, a second connector 208, and a height adjusting member 209. The steering tube coupling member 202, the handlebar coupling member 204, the first connector 206, the second connector 208, and the height adjusting member 209 operate in a manner substantially similar to the manner in which the steering tube coupling member 202, the handlebar coupling member 204, the first connector 206, the second connector 208, and the height adjusting member 209 of apparatus 200 operate.

In certain embodiment, the apparatus 300 also includes a controller 306 configured to deliver a control signal 310 to the height adjusting member 209. The control signal 310, in certain embodiments, is any signal configured to actuate the height adjusting member 209 to selectively adjust the height of the handlebar coupling member 204 relative to a height of the steering tube coupling member 202. For example, in embodiments wherein the height adjusting member 209 is a hydraulic piston 210, the control signal 310 is delivery or removal of hydraulic fluid. In embodiments wherein the height adjusting member 209 is a pneumatic actuator or pneumatic piston, the control signal 310 is delivery or removal of a compressed gas. For piezoelectric and electro mechanical actuators, the control signal 310 is the delivery or removal of an electrical current. In embodiments wherein the height adjusting member 209 is a mechanical actuator or mechanical lever, the control signal is delivery or removal of a mechanical force from the user.

In the embodiment illustrated in FIGS. 3A and 3B, the height adjusting member 209 is a hydraulic piston 210. The controller 306 is coupled to the height adjusting member 209 by a length of cable 308. The cable 308 allows a user to position the controller 306 on the handlebars 124 of the bicycle 100 or anywhere else the user finds convenient.

In an exemplary embodiment, the cable 308 is a Bowden cable. One of skill in the art will recognize that a Bowden cable is a type of flexible cable used to transmit mechanical force or energy by the movement of an inner cable (most commonly of steel or stainless steel) relative to a hollow outer cable housing. Linear movement of the inner cable transmits a pulling or pushing force to open or close a hydraulic port (not shown) in the height adjusting member 209 to selectively deliver hydraulic fluid to the height adjusting member 209. In such an embodiment, the control signal 310 is the delivery or removal of the hydraulic fluid from the height adjusting member 209. In the embodiment illustrated in FIGS. 3A and 3B the controller 306 includes a depressible button 312 that when manipulated causes the inner cable of the Bowden cable to extend or retract to open or close the hydraulic port in the height adjusting member 209.

Depressing the button 312 of the controller 306 forces the delivery of the hydraulic fluid to the height adjusting member 209 and extends the length of the height adjusting member 209. When the length of the height adjusting member 209 is extended, the height adjusting member 209 raises the height of the handlebar coupling member 204 to the raised position 302 as illustrated in FIG. 3A. In certain embodiments, the controller 306 is configured to lock the handlebar coupling member 204 in the raised position 302 by limiting further delivery or removal of hydraulic fluid from within the height adjusting member 209.

The controller 306, in certain embodiments, is further configured to selectively remove at least a portion of the hydraulic fluid from the height adjusting member 209. In such an embodiment, the control signal 310 is the removal of at least a portion of the hydraulic fluid from the height adjusting member 209. In one embodiment, the removal of the hydraulic fluid from the height adjusting member 209 is accomplished by partially withdrawing the button 312 to draw hydraulic fluid out of the height adjusting member 209. Removal of the hydraulic fluid from the height adjusting member 209 reduces the length of the height adjusting member 209. When the length of the height adjusting member 209 is reduced, the height adjusting member 209 lowers the height of the handlebar coupling member 204 to the lowered position 304 as illustrated in FIG. 3B. In certain embodiments, the controller 306 is configured to lock the handlebar coupling member 204 in the lowered position 304 by limiting further delivery or removal of hydraulic fluid from within the height adjusting member 209.

One of skill in the art will recognize that in other embodiments, the controller 306 may be any other device configured to selectively deliver and remove hydraulic fluid from the height adjusting member 209. For example, in one embodiment the controller 306 is a hydraulic controller that is hydraulically coupled to the height adjusting member 209 by a length of hydraulic tubbing. In such an embodiment, the hydraulic controller 306 includes a reservoir containing a hydraulic fluid for delivery to the height adjusting member 209. Depressing the button 312 forces the delivery of the hydraulic fluid to the height adjusting member 209 and extends the length of the height adjusting member 209. The hydraulic controller 306, in certain embodiments, is further configured to selectively remove at least a portion of the hydraulic fluid from the height adjusting member 209. In one embodiment, the removal of the hydraulic fluid from the height adjusting member 209 is accomplished by partially withdrawing the button 312 from within the reservoir in the hydraulic controller 306 to draw hydraulic fluid into the reservoir in the hydraulic controller 306. Removal of the hydraulic fluid from the height adjusting member 209 reduces the length of the height adjusting member 209 to position the handlebar coupling member 204 to the lowered position 304 as illustrated in FIG. 3B.

While the embodiments illustrated in FIGS. 3A and 3B depict the handlebar coupling member 204 as being positionable in a raised position 302 or a lowered position 304, one of skill in the art will recognize that the handlebar coupling member 204 may be positioned anywhere in between these two positions. In this manner, the height adjusting member 209 is configured to selectively adjust a height of the handlebar coupling member 204 relative to a height of the steering tube coupling member 202. Furthermore, while the embodiment illustrated in FIG. 3B depicts the handlebar coupling member 204 at approximately the same height as the steering tube coupling member 202, one of skill in the art will recognize that in certain embodiments, the apparatus 300 may be configured to position the handlebar coupling member 204 at a lower height than the steering tube coupling member 202 when the handlebar coupling member 204 is positioned in the lowered position 304.

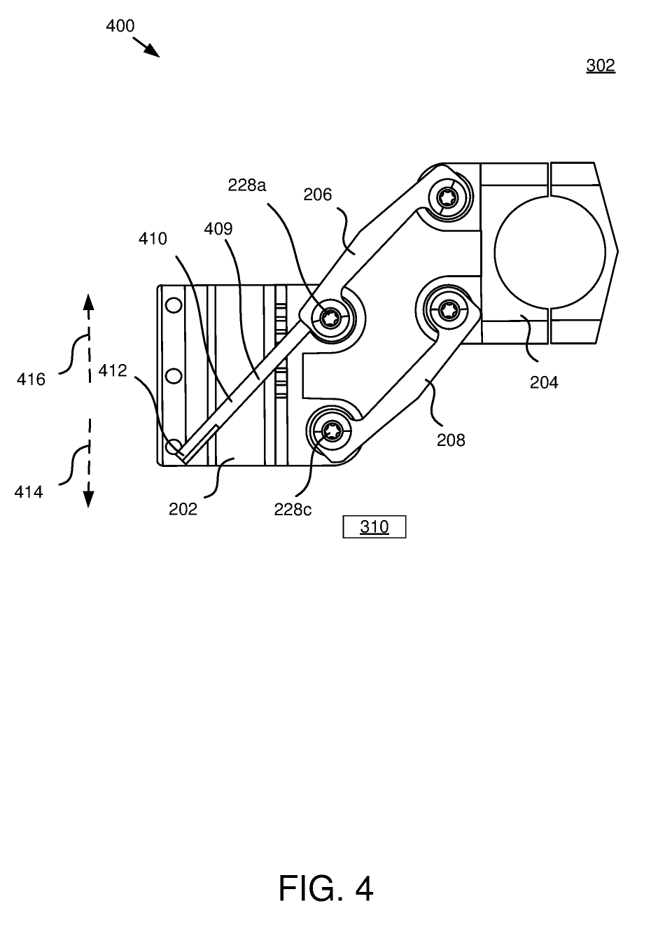

FIG. 4 is a side view illustrating an apparatus 400 to adjust a height of a handlebar 124 with the handlebar coupling member 204 positioned in a raised position 302 in accordance with one embodiment of the present invention. The apparatus 400 of FIG. 4 is substantially similar to the apparatus 200 of FIG. 2 and the apparatus 300 of FIGS. 3A and 3B. Accordingly, in certain embodiments, the apparatus 400 includes a steering tube coupling member 202, a handlebar coupling member 204, a first connector 206, a second connector 208 and a height adjusting member 409. The steering tube coupling member 202, the handlebar coupling member 204, the first connector 206, and the second connector 208 operate in a manner substantially similar to the manner in which the steering tube coupling member 202, the handlebar coupling member 204, the first connector 206, and the second connector 208 of apparatus 200 and apparatus 300 operate.

In the embodiment illustrated in FIG. 4 the height adjusting member 409 is a mechanical lever 410. In certain embodiments, the mechanical lever is coupled to the first connector 206. In other embodiments, the mechanical lever 410 is coupled to the second connector 208. In one embodiment, the mechanical lever 410 is integrally formed with the first connector 206 or second connector 208. In other embodiments, the mechanical lever 410 may be mechanically coupled to the first connector 206 or second connector 208. The mechanical lever 410 and the first connector 206 or second connector 208 pivot around either fastening element 228a or fastening element 228c depending on

The mechanical lever 410 extends in a direction opposite the first connector 206 or second connector 208. Physical pressure applied to an end 412 of the mechanical lever 410 by the user operates to selectively raise or lower the handlebar coupling member 204 with respect to the steering tube coupling member 202. Pressure applied in the direction indicated by arrow 414 raises the handlebar coupling member 204 with respect to the steering tube coupling member 202. Pressure applied in the direction indicated by arrow 416 lowers the handlebar coupling member 204 with respect to the steering tube coupling member 202. In such embodiments, the control signal 310 includes a physical pressure applied to the mechanical lever 410.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to adjust a height of a handlebar, the apparatus comprising:
a steering tube coupling member;
a handle bar coupling member;
at least one connector adjustably coupling the steering tube coupling member to the handlebar coupling member; and
a height adjusting member coupled to at least one of the steering tube coupling member, the handle bar coupling member and the at least one connector, wherein actuation of the height adjusting member selectively adjusts a height of the handlebar coupling member relative to a height of the steering tube coupling member.

2. The apparatus of claim 1, wherein the height adjusting member comprises a linear height adjusting member configured to extend and retract linearly along a longitudinal axis.

3. The apparatus of claim 1, wherein the height adjusting member comprises a height adjusting member selected from the group comprising a hydraulic actuator, a pneumatic actuator, a piezoelectric actuator, a mechanical actuator, a mechanical lever, and an electro mechanical actuator.

4. The apparatus of claim 1, further comprising a controller coupled to the height adjusting member, the controller configured to deliver a control signal to the height adjusting member.

5. The apparatus of claim 4, wherein the height adjusting member comprises a hydraulic piston and wherein the control signal comprises delivery of a hydraulic fluid to the hydraulic piston, wherein delivery of the hydraulic fluid to the hydraulic piston extends a length of the hydraulic piston to position the handlebar coupling member in a raised position relative to a position of the steering tube coupling member.

6. The apparatus of claim 4, wherein the height adjusting member comprises a hydraulic piston and wherein the control signal comprises removal of at least a portion of a hydraulic fluid from the hydraulic piston, wherein removal of at least a portion of the hydraulic fluid from the hydraulic piston reduces a length of the hydraulic piston to position the handlebar coupling member in a lowered position relative to a position of the steering tube coupling member.

7. The apparatus of claim 1, wherein the at least one connector comprises:
a first connector pivotably coupled to a top end of the steering tube coupling member at a first end on the first connector and pivotably coupled to a top end of the handlebar coupling member at a second end of the first connector; and
a second connector pivotably coupled to a bottom end of the steering tube coupling member at a first end on the second connector and pivotably coupled to a bottom end of the handlebar coupling member at a second end of the second connector.

8. The apparatus of claim 7, wherein the first connector remains substantially parallel to the second connector when the height of the handle bar coupling member is adjusted relative to the height of the steering tube coupling member.

9. The apparatus of claim 7, wherein the height adjusting member is pivotably coupled to the bottom end of the steering tube coupling member at the first end of the height adjusting member and wherein the height adjusting member is pivotably coupled to the top end of the handle bar coupling member at the second end of the height adjusting member.

10. The apparatus of claim 9, wherein delivery of a hydraulic fluid to the height adjusting member extends a length of the height adjusting member to position the handlebar coupling member in a raised position relative to a position of the steering tube coupling member, wherein removal of at least a portion of the hydraulic fluid from the height adjusting member reduces a length of the height adjusting member to position the handlebar coupling member in a lowered position relative to the position of the steering tube coupling member.

11. An adjustable bicycle stem comprising:
a steering tube coupling member having a top end disposed opposite a bottom end;
a handlebar coupling member having a top end disposed opposite a bottom end;
a first connector pivotably coupled to the top end of the steering tube coupling member at a first end on the first connector and pivotably coupled to the top end of the handlebar coupling member at a second end of the first connector;
a second connector pivotably coupled to the bottom end of the steering tube coupling member at a first end on the second connector and pivotably coupled to the bottom end of the handlebar coupling member at a second end of the second connector; and
a hydraulic piston pivotably coupled to one of the top end of the steering tube coupling member and the bottom end of the steering tube coupling member at a first end of the hydraulic piston, the hydraulic piston pivotably coupled to one of the top end of the handlebar coupling member and the bottom end of the handlebar coupling member at a second end of the hydraulic piston.

12. The adjustable bicycle stem of claim 11, wherein the hydraulic piston is configured to selectively adjust a height of the handlebar coupling member relative to a height of the steering tube coupling member.

13. The adjustable bicycle stem of claim 11, further comprising a controller coupled to the hydraulic piston, the controller configured to selectively deliver a hydraulic fluid to the hydraulic piston.

14. The adjustable bicycle stem of claim 13, wherein delivery of the hydraulic fluid to the hydraulic piston extends a length of the hydraulic piston.

15. The adjustable bicycle stem of claim 13, wherein the controller is further configured to selectively remove at least a portion of the hydraulic fluid from the hydraulic piston.

16. The adjustable bicycle stem of claim 13, wherein removal of hydraulic fluid from the hydraulic piston reduces a length of the hydraulic piston.

17. A bicycle stem for adjusting a height of a handlebar, the bicycle stem comprising:
a steering tube coupling member having a top end disposed opposite a bottom end;
a handlebar coupling member having a top end disposed opposite a bottom end;
a first connector pivotably coupled to the top end of the steering tube coupling member at a first end on the first connector and pivotably coupled to the top end of the handlebar coupling member at a second end of the first connector;
a second connector pivotably coupled to the bottom end of the steering tube coupling member at a first end on the second connector and pivotably coupled to the bottom end of the handlebar coupling member at a second end of the second connector;
a hydraulic piston pivotably coupled to the bottom end of the steering tube coupling member at a first end of the hydraulic piston, the hydraulic piston pivotably coupled to the top end of the handlebar coupling member at a second end of the hydraulic piston; and
a controller coupled to the hydraulic piston, the controller configured to selectively deliver a hydraulic fluid to the hydraulic piston, wherein the hydraulic piston is configured to selectively adjust a height of the handlebar coupling member relative to a height of the steering tube coupling member upon delivery of the hydraulic fluid to the hydraulic piston.

18. The bicycle stem of claim 17, wherein delivery of hydraulic fluid to the hydraulic piston extends a length of the hydraulic piston to raise the height of the handlebar coupling member relative to the height of the steering tube coupling member.

19. The bicycle stem of claim 17, wherein the controller is further configured to selectively remove at least a portion of the hydraulic fluid from the hydraulic piston.

20. The bicycle stem of claim 19, wherein removal of at least a portion of the hydraulic fluid from the hydraulic piston reduces a length of the hydraulic piston to lower the height of the handlebar coupling member relative to the height of the steering tube coupling member.
